(19) United States
(12) Patent Application Publication
(10) Pub. No.: US 2006/0008697 A1
(43) Pub. Date: Jan. 12, 2006

(54) Supported catalyst and fuel cell using the same

(76) Inventors: Hae-kyoung Kim, Seoul (KR); Chan-ho Pak, Seoul (KR); Sang-hyuk Suh, Seoul (KR); Dae-jong Yoo, Yongin-si (KR); Hyuk Chang, Seongnam-si (KR)

Correspondence Address: MCGUIREWOODS, LLP, 1750 TYSONS BLVD, SUITE 1800, MCLEAN, VA, 22102, US

(21) Appl. No.: 11/176,281

(22) Filed: Jul. 8, 2005

(30) Foreign Application Priority Data
Jul. 8, 2004 (KR) 10-2004-0052970

(51) Int. Cl. H01M 4/86; H01M 4/96; H01M 4/88; B01J 31/08

(52) U.S. Cl. 429/42; 429/43; 502/101; 502/150

(57) ABSTRACT

A supported catalyst, an electrode including the catalyst, and a fuel cell using the electrode are provided. The supported catalyst comprises a carbon-based catalyst support, catalytic metal particles that are adsorbed onto a surface of the carbon-based catalyst support, and an ionomer that is chemically or physically adsorbed to the surface of the carbon-based catalyst support and has a functional group on an end that is capable of providing proton conductivity. In the supported catalyst, the catalyst support performs the function of transporting protons in an electrode. When using an electrode prepared using the supported catalyst, a fuel cell having improved energy density and fuel efficiency may be prepared.

### BACKGROUND OF THE INVENTION

This application claims priority to and the benefit of Korean Patent Application No. 10-2004-0052970, filed on Jul. 8, 2004, in the Korean Intellectual Property Office, the disclosure of which is incorporated herein in its entirety by reference.

1. Field of the Invention

The present invention relates to a supported catalyst that has proton conductivity, a method of preparing the same, and a fuel cell using an electrode that is prepared using the supported catalyst.

2. Description of the Related Art

A fuel cell, which is a source of clean energy with the potential to replace fossil fuels, has high power density and high energy-conversion efficiency. Also, fuel cells can operate at ambient temperatures and can be miniaturized and hermetically sealed. Thus, fuel cells may be used in zero-emission vehicles, power generating systems, mobile telecommunications equipment, medical equipment, military equipment, space equipment, and portable electronic devices.

Proton exchange membrane fuel cells (PEMFC) or direct methanol fuel cells (DMFC) are power generating systems that produce electricity through an electrochemical reaction between methanol, water, and oxygen. These fuel cells include an anode and a cathode where liquid and gas are supplied and a proton conductive membrane which is interposed between the anode and the cathode.

A catalyst contained in the anode decomposes hydrogen or methanol to form protons. The protons pass through the proton conductive membrane and then react with oxygen in the cathode with the aid of the catalyst to generate electricity. The catalysts contained in the cathode and the anode of a fuel cell promote the electrochemical oxidation of fuel and the electrochemical reduction of oxygen, respectively.

In a PEMFC, the anode and the cathode contain a catalyst that includes platinum particles that are dispersed in an amorphous carbon support. In a DMFC, the anode contains PtRu and the cathode contains platinum particles or a catalyst including platinum particles that are dispersed in an amorphous carbon support.

To optimize the cost effectiveness of a DMFC, the amount of catalyst used can be minimized. Thus, efforts are being made to reduce the amount of catalyst that is used in the anode and the cathode by using a carbon support that is capable of increasing catalytic activity or a degree of dispersion more than an amorphous carbon support.

### SUMMARY OF THE INVENTION

The present invention provides a supported catalyst that easily transports protons, a method of preparing the supported catalyst, an electrode that uses the supported catalyst, and a fuel cell that includes the electrode and has improved energy density and fuel efficiency.

Additional features of the invention will be set forth in the description which follows, and in part will be apparent from the description, or may be learned by practice of the invention.

The present invention discloses a supported catalyst comprising a carbon-based catalyst support, catalytic metal particles that are adsorbed onto a surface of the carbon-based catalyst support, and an ionomer that is chemically bound or physically absorbed onto the surface of the carbon-based catalyst support and has a functional group on an end that is capable of providing proton conductivity.

The present invention also discloses a method of preparing the supported catalyst, comprising combining a carbon-based catalyst support, a polymerizable monomer, a polymerization initiator, and a solvent, and reacting the mixture to fix an ionomer to a surface of the carbon-based catalyst support through a chemical bond. The method further comprises reacting the resulting compound to introduce a functional group that is capable of providing proton conductivity onto an end of the ionomer and impregnating catalytic metal particles into the resulting catalyst support.

The present invention also discloses an electrode comprising a supported catalyst comprising a carbon-based catalyst support, catalytic metal particles that are absorbed on a surface of the carbon-based catalyst support, and an ionomer that is chemically bound or physically absorbed to the carbon-based catalyst support and has a functional group on an end that is capable of providing proton conductivity.

The present invention also discloses a fuel cell comprising an electrode comprising a supported catalyst, comprising a carbon-based catalyst support, catalytic metal particles adsorbed on a surface of the carbon-based catalyst support, and an ionomer that is chemically bound or physically absorbed to the surface of the carbon-based catalyst support and has a functional group on an end that is capable of providing proton conductivity.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 schematically illustrates the structure of a supported catalyst of the present invention.

FIG. 2 schematically illustrates the structure of a general supported catalyst.

FIG. 3 illustrates the structure of a fuel cell according to an exemplary embodiment of the present invention.

FIG. 4 is an x-ray photoelectron spectroscopy (XPS) spectrum of a supported catalyst of Example 1 of the present invention, which illustrates variation in components before and after sulfonating by adding H₂SO₄.

FIG. 5 illustrates a differential scanning calorimeter (DSC) result and a thermogravimetric analysis (TGA) result for the supported catalyst prepared according to Example 1 of the present invention.

FIG. 6 illustrates variation of cell potential with respect to current density of a fuel cell prepared according to Example 2 of the present invention.

### DETAILED DESCRIPTION OF THE ILLUSTRATED EMBODIMENTS

The supported catalyst of the present invention transports protons in an electrode, thereby increasing the power-generating efficiency. When using an electrode comprising the supported catalyst, a fuel cell having improved performance, energy density and fuel efficiency, may be prepared.

When using a catalyst that has been impregnated into a conventional support, ions and electrons are produced through an electrochemical reaction of fuel, but the conventional supported catalyst cannot transport the ions. Thus, an ionomer such as Nafion® is used with the supported catalyst when forming the electrode to easily transport the ions, thereby increasing the coefficient of catalyst utilization. The addition of the ionomer increases the manufacturing costs of the electrode.

In the present invention, a support functions as a proton transporting material that is essential in the formation of an electrode. Thus, the amount of ionomer that is separately added is reduced or a support is prepared without using the ionomer. As a result, the electrode can easily be prepared and its manufacturing costs can be reduced.

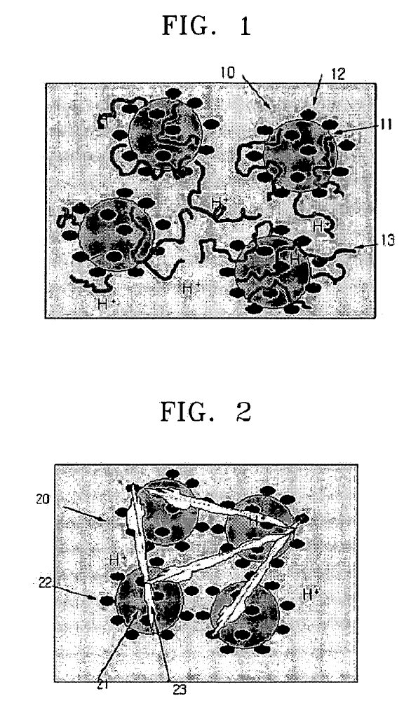

Referring to FIG. 1, which schematically illustrates the structure of a supported catalyst according to an exemplary embodiment of the present invention, a supported catalyst 10 comprises a catalyst support 11, catalytic metal particles 12 that are adsorbed onto the surface of the catalyst support 11, and an ionomer 13 that is chemically bound (for example, grafted) or physically absorbed to the surface of the catalyst support 11. The ionomer 13 has a functional group, for example, an acidic group such as a sulfonic acid group (—SO₃H) that is capable of transporting protons.

Referring to FIG. 2 which illustrates the structure of a conventional supported catalyst, a supported catalyst 20 has catalytic metal particles 22 that are adsorbed onto the surface of the catalyst support 21 and an ionomer 23 that is located near the catalyst support 21 and the catalytic metal particles 22, but a chemical bond is not formed between the ionomer 23 and the catalyst support 21 unlike in FIG. 1.

As illustrated in FIG. 1, in the present invention, the ionomer is grafted onto the catalyst support 11 comprising an electrode of a fuel cell to act as a path for protons. Thus, the concentration of the ionomer used in the electrode may be reduced, the protons may be rapidly transported, and hydrophilicity in a fuel cell may be improved by using intrinsic surface properties of the support.

In the present invention, the ionomer is used similarly to a polyelectrolyte.

A method for preparing the supported catalyst of the present invention begins by first mixing and reacting a carbon-based catalyst support, a polymerizable monomer, a polymerization initiator, and a solvent to graft the ionomer onto the surface of the carbon catalyst support. This reaction is stimulated by heat or by irradiating light. The temperature varies depending on types of monomer and initiator used, and ranges from about 50° C. to about 65° C., particularly about 55° C. to about 60° C. If the temperature is below this range, the polymerization initiator does not initiate polymerization and grafting does not occur. If the temperature is above this range, the molecular weight of the resulting polymer is excessively low.

The carbon-based catalyst support is not particularly restricted, but is porous and has a surface area of about 300 m²/g or more, particularly about 300-1200 m²/g. The support also may have an average particle diameter of about 20-200 nm, particularly about 30-150 nm. If the surface area is below this range, the impregnating ability of the catalyst particles is insufficient.

Examples of a carbon-based catalyst support that satisfies the requirements described above include carbon black, Ketjen black, acetylene black, activated carbon powder, carbon molecular sieve, carbon nanotube, activated carbon having micropores, and mesoporous carbon. Ketjen black with a surface area of about 406 m²/g is preferably used. The carbon-based catalyst support may be hydrophilically modified, if necessary.

The polymerizable monomer may be any compound that has an unsaturated double bond which reacts with a hydroxyl (—OH) group that is present on the surface of the carbon-based catalyst support. Examples of the polymerizable monomer include but are not limited to, styrene, acrylic monomer, methacrylic monomer, arylsulfone, a benzene compound, and the like. The concentration of the polymerizable monomer may be about 3,000-20,000 parts by weight, and preferably about 6,000-10,000 parts by weight, based on 100 parts by weight of the carbon-based catalyst support. If the concentration of the polymerizable monomer is below this range, the proton conductivity decreases. If the concentration of the polymerizable monomer is above this range, the electroconductivity decreases.

The polymerization initiator initiates the polymerization of the polymerizable monomer. Examples of the polymerization initiator may include, but are not limited to persulfate, azobisisobutyronitrile (AIBN), benzoyl peroxide, and lauryl peroxide. The concentration of the polymerization initiator may be about 0.1-5 parts by weight, particularly about 0.3-0.5 parts by weight, based on 100 parts by weight of the polymerizable monomer. If the concentration of the polymerization initiator is below this range, the molecular weight of a resulting polymer may increase excessively. If the concentration of the polymerization initiator is above this range, the molecular weight of a resulting polymer is too low.

The resulting product is then filtered, dried, and worked up. Then, a chemical reaction is performed to introduce a functional group that provides proton conductivity at an end of the ionomer that is obtained according to the above steps. An example of such a chemical reaction includes sulfonation using sulfuric acid, etc.

The ionomer that is formed according to the above procedures has a weight average molecular weight of about 500-10,000 g/mol, and an example thereof includes a compound having the following chemical structure: 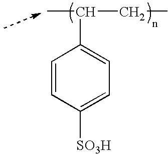
where the arrow points to a position that is to be connected to the surface of the carbon support and n is an integer from 2 to 50.

The concentration of the ionomer is about 1-50 parts by weight, and preferably about 2-10 parts by weight, based on 100 parts by weight of the carbon-based catalyst support.

Catalytic metal particles are then impregnated into the resulting catalyst support to form the supported catalyst of the present invention. The impregnating process of the catalytic metal particles is not particularly restricted, and a gas phase impregnation using a reducing agent will now be described.

The catalyst support is mixed with a solution containing a catalytic metal precursor. Then, a reducing agent or a solution containing a reducing agent is added thereto to allow the catalytic metal particles to adsorb onto the catalyst support.

The solution containing the catalytic metal precursor may comprise a catalytic metal precursor and a solvent. Examples of the solvent include water, an alcohol such as methanol, ethanol, and propanol, acetone, and mixtures thereof. The concentration of the catalytic metal precursor is about 30-150 parts by weight based on 100 parts by weight of the solvent.

Examples of a platinum precursor may include, but are not limited to tetrachloroplatinate (H₂PtCl₄), hexachloroplatinate (H₂PtCl₆), potassium tetrachloroplatinate (K₂PtCl₄), potassium hexachloroplatinate (H₂PtCl₆), or a mixture thereof. Examples of a ruthenium precursor may include but are not limited to (NH₄)₂[RuCl₆], (NH₄)₂[RuCl₅H₂O] and the like, and examples of a gold precursor may include but are not limited to H₂[AuCl₄], (NH₄)₂[AuCl₄], H[Au(NO₃)₄]H₂O, and the like.

In the case of an alloy catalyst, a mixture of precursors that have a mixing ratio that corresponds to a desired atomic ratio of metals is used.

The reducing agent reduces a catalytic metal precursor into a corresponding catalytic metal. Examples of the reducing agent may include, but are not limited to hydrogen gas, hydrazine, formaldehyde, formic acid, polyols, and the like. Examples of the polyols include ethylene glycol, glycerol, diethylene glycol, triethylene glycol, for example.

The solution containing a reducing agent also contains the same solvent that was used in the preparation of the solution containing the catalytic metal precursor.

The concentration of the ionomer grafted to the catalyst support in the supported catalyst obtained according to the above steps may be identified through thermogravimetric analysis (TGA). The concentration of the ionomer grafted to the catalyst support, determined through TGA is about 2-10 parts by weight, based on 100 parts by weight of the catalyst support.

The fraction of the ionomer in the surface area of the carbon-based catalyst support is not particularly restricted, but may be about 2%-10% based on the total surface area of the carbon-based catalyst support according to an exemplary embodiment of the present invention.

A metal adsorbed to the catalyst support may include, but is not limited to platinum, ruthenium, palladium, rhodium, iridium, osmium, and gold. The average particle diameter of the catalytic metal particle is about 2-7 nm. The concentration of the catalytic metal particle is about 5-80 parts by weight based on 100 parts by weight of the carbon-based catalyst support.

The supported catalyst prepared of the present invention may be used in an electrode catalyst layer of a fuel cell such as a DMFC. It may also be used as a catalyst for hydrogenation, dehydrogenatiori, coupling, oxidation, isomerization, decarboxylation, hydrocracking, alkylation, and the like.

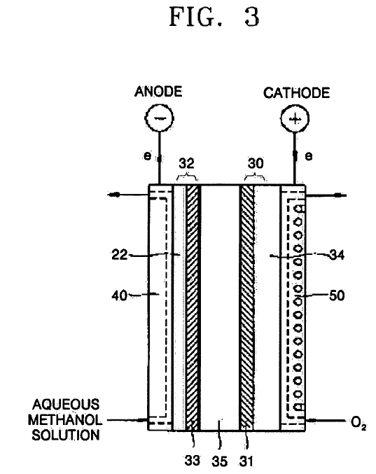

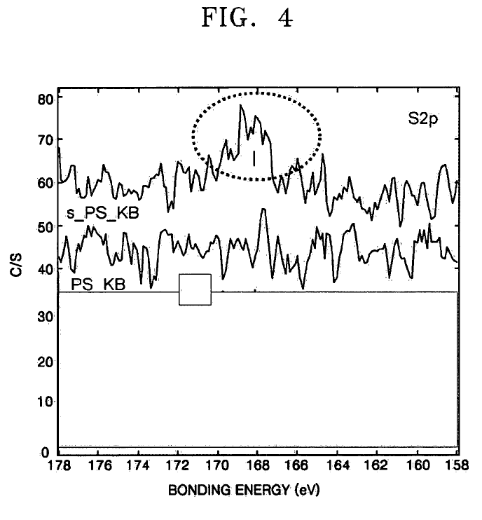

A DMFC according to an exemplary embodiment of the present invention using the supported catalyst will now be described with reference to FIG. 3.

As shown in FIG. 3, the DMFC includes an anode 32 where fuel is supplied, a cathode 30 where an oxidant is supplied, and an electrolyte membrane 35 that is interposed between the anode 32 and the cathode 30. Generally, the anode 32 comprises an anode diffusion layer 22 and an anode catalyst layer 33 and the cathode 30 comprises a cathode diffusion layer 34 and a cathode catalyst layer 31. In the present invention, the anode catalyst layer 33 and the cathode catalyst layer 31 comprise the supported catalyst described above.

A bipolar plate 40 has a path for supplying fuel to the anode 32 and acts as an electron conductor for transporting electrons that are produced in the anode to an external circuit or an adjacent unit cell. A bipolar plate 50 has a path for supplying an oxidant to the cathode 30 and acts as an electron conductor for transporting electrons supplied that are from the external circuit or the adjacent unit cell to the cathode 30. In the DMFC, an aqueous methanol solution is typically used as the fuel that is supplied to the anode 32 and air is typically used as the oxidant that is supplied to the cathode 30.

The aqueous methanol solution is transported to the anode catalyst layer 33 through the anode diffusion layer 22 and is decomposed into electrons, protons, carbon dioxide, and the like. The protons are transported to the cathode catalyst layer 31 through the electrolyte membrane 35, the electrons are transported to an external circuit, and the carbon dioxide is discharged to the outside. The protons that are transported through the electrolyte membrane 35, the electrons that are supplied from an external circuit, and the oxygen in the air that is transported through the cathode diffusion layer 32 react in the cathode catalyst layer 31 to produce water.

In a DMFC, the electrolyte membrane 35 may act as a proton conductor, an electron insulator, a separator, and the like. The separator prevents unreacted fuel from being transported to the cathode or unreacted oxidant from being transported to the anode.

In the DMFC, the electrolyte membrane 35 may comprise a cation exchanging polymer electrolyte such as a highly fluorinated polymer (Ex: Nafion®), that is sulfonated and has fluorinated alkylene forming a main chain and a side chain of fluorinated vinyl ether having a sulfonic acid group on an end.

The present invention will be described in greater detail with reference to the following examples. The following examples are for illustrative purposes and are not intended to limit the scope of the invention.

### EXAMPLES 1

60 g of styrene and 0.18 g of azobisisobutyronitrile as a polymerization initiator were mixed, and then 1 g of Ketjen black was added to the mixture. The resulting mixture was heated to about 65° C. for 8 hours.

The reaction mixture was then filtered and dried. Next, 10 M H₂SO₄ was added to the mixture and the solution was stirred for about 240 minutes. Then, a catalyst particle solution of 0.6 g of H₂PtCl₆ in 3 mL of acetone was added, and then the solution was stirred for 1 hour. Then, the resulting solution was reduced in a furnace under a hydrogen atmosphere at 100° C. for 4 hours.

Variations in components of the supported catalyst obtained according to Example 1 were investigated before and after the sulfonation process of adding H₂SO₄ through X-ray Photoelectron Spectroscopy (XPS) and the results are illustrated in FIG. 4. In FIG. 4, S_PS_KB refers to a sample after a sulfonation process and PS KB refers to a sample before sulfonation.

As is apparent from FIG. 4, a sulfonic acid group peak shown in a dotted circle is detected after sulfonation.

The moisture content in the catalyst after sulfonation was also measured. Specifically, the dried catalyst, which had been obtained by impregnating the metal particles into the catalyst support in the furnace at 100° C., was stored at room temperature and then the moisture content in the stored catalyst was measured. The moisture content of Ketjen black was also studied.

As a result, it was found that the water content of Ketjen black was about 0.71% and that of the catalyst support prepared according to Example 1 was about 15%. These results are attributed to the effects of the ionomer and an increase in hydrophilicity of the catalyst support during reactions.

Also, the following experiment was performed on the supported catalyst to study the binding of the catalyst support and styrene.

The catalyst support obtained in Example 1 was added to a solution of tetrahydrofuran (THF) and the mixture was stirred. After removing the solvent, the residue was dissolved 0.8 mL of THF-d8 and its nuclear magnetic resonance (NMR) spectrum was studied. A peak of styrene was not observed in the NMR spectrum, indicating that the polymer formed using styrene was grafted to the surface of Ketjen black.

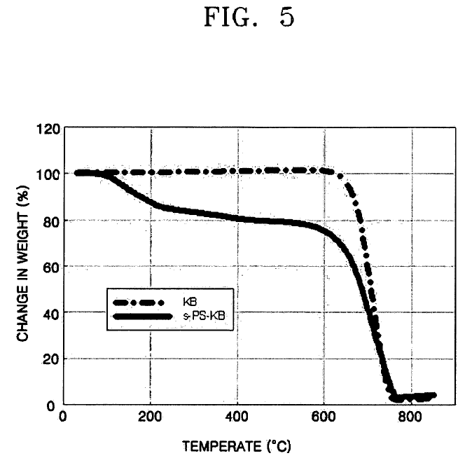

Differential scanning calorimetry and thermogravimetric analysis were performed on the supported catalyst obtained according to Example 1 and the results are illustrated in FIG. 5. FIG. 5 illustrates the change in weight with respect to the temperature for Ketjen black without grafting the polymer and Ketjen black after grafting and sulfonation. The change in weight due to decomposition of the polymer is displayed in FIG. 5.

Referring to FIG. 5, by heating the mixture of styrene, the polymerization initiator, and Ketjen black at 65° C. for 8 hours, the polymer was grafted to Ketjen black and the concentration of the grafted polymer was identified by a loss in weight in the thermogravimetric analysis.

### EXAMPLE 2

A fuel cell using a catalyst layer obtained using the supported catalyst of Example 1 was prepared as follows.

In the fuel cell of the present Example, an anode was prepared by spraying a composition for a catalyst layer on a diffusion layer, a cathode was prepared by spraying the catalyst obtained in Example 1 on a diffusion layer, and a Nafion 115® membrane was used as an electrolyte membrane. The resulting anode, cathode, and electrolyte membrane were joined under a pressure of 5 MPa at 120° C. to prepare a membrane electrode assembly (MEA). MEA refers to a structure in which a catalyst layer and an electrode are laminated on both surfaces of a proton conductive polymer membrane.

Evaluation of Performance of the Fuel Cell

A bipolar plate for supplying fuel and a bipolar plate for supplying an oxidant were both attached to each of the anode and the cathode, respectively, of the fuel cell that was prepared according to Example 2, and then the performance of the fuel cell was measured. The flow rate of an 8 wt % aqueous methanol solution (fuel) was 3 mL/min, the flow rate of air (oxidant) was 50 mL/min, and the operating temperature was 50° C.

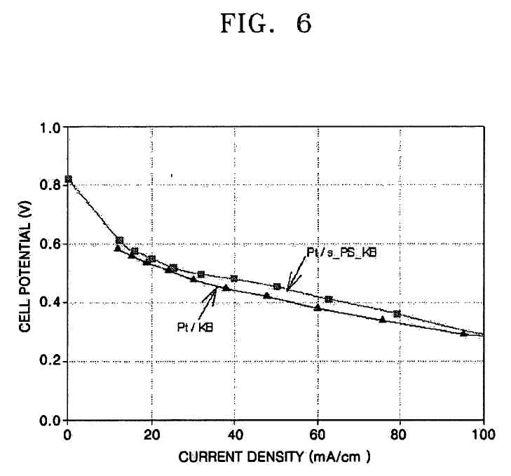

The change in cell potential with respect to current density of the fuel cell of Example 2 was studied and the results are illustrated in FIG. 6. In FIG. 6, Pt/s_PS_KB refers to the fuel cell of Example 2 and Pt/KB refers to a fuel cell comprising a Comparative Example supported catalyst that was prepared in the same manner as in Example 1 except that polystyrene and a polymerization initiator were not used in the preparation of the Comparative Example supported catalyst.

FIG. 6 illustrates examples in which an electrode using the supported catalyst that was prepared in Example 1 and an electrode using a conventional supported catalyst are applied to a fuel cell. As seen from FIG. 6, the supported catalyst prepared in Example 1 provides proton conductivity, and thus has better performance than the conventional supported catalyst.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A supported catalyst, comprising:
a carbon-based catalyst support;
catalytic metal particles that are adsorbed onto a surface of the carbon-based catalyst support; and
an ionomer that is chemically bound or physically adsorbed to the surface of the carbon-based catalyst support,
wherein the ionomer has a functional group on an end, the functional group being capable of providing proton conductivity.

2. The supported catalyst of claim 1,
wherein the functional group is selected from the group consisting of a sulfonic acid group (—SO₃H), a carboxylic acid group (COOH), or a phosphoric acid group.

3. The supported catalyst of claim 1,
wherein a concentration of the ionomer is about 1-50 parts by weight based on 100 parts by weight of the carbon-based catalyst support.

4. The supported catalyst of claim 1,
wherein the ionomer is obtained through a first chemical reaction between a hydroxyl group (—OH) present in the carbon-based catalyst support and a polymerizable monomer, and a second chemical reaction that provides a resulting compound of the first chemical reaction with proton conductivity.

5. The supported catalyst of claim 1,
wherein the ionomer is derived from at least one selected from the group consisting of styrene, acrylic monomer, methacrylic monomer, arylsulfone, and a phenylic compound.

6. The supported catalyst of claim 1,
wherein the ionomer has a weight average molecular weight of about 500-10,000 g/mol.

7. The supported catalyst of claim 1,
wherein a surface area of the supported catalyst is about 300 m²/g or greater and
wherein an average particle diameter of the supported catalyst is about 20-200 nm.

8. The supported catalyst of claim 1,
wherein the carbon-based catalyst support is at least one selected from the group consisting of carbon black, Ketjen black, acetylene black, activated carbon powder, carbon molecular sieve, carbon nanotube, activated carbon having micropores, and mesoporous carbon.

9. The supported catalyst of claim 1,
wherein the catalytic metal particles are at least one selected from the group consisting of platinum, ruthenium, palladium, rhodium, iridium, osmium and gold.

10. The supported catalyst of claim 1,
wherein the catalytic metal particles have an average particle diameter of about 2-7 nm.

11. The supported catalyst of claim 1,
wherein a concentration of the catalytic metal particles is about 5-80 parts by weight based on 100 parts by weight of the carbon-based catalyst support.

12. A method for preparing a supported catalyst, comprising:
preparing a mixture comprising a carbon-based catalyst support, a polymerizable monomer, a polymerization initiator, and solvent;
reacting the mixture to bond an ionomer to the carbon-based catalyst support;
reacting the ionomer bonded to the carbon-based catalyst support to introduce a functional group at an end of the ionomer, the functional group being capable of providing proton conductivity; and
impregnating catalytic metal particles into the carbon-based catalyst support.

13. The method of claim 12,
wherein the polymerizable monomer is at least one selected from the group consisting of styrene, acrylic monomer, methacrylic monomer, arylsulfone, and a phenylic compound.

14. The method of claim 12,
wherein the reaction of the mixture of the carbon-based catalyst support, the polymerizable monomer, the polymerization initiator, and the solvent is achieved by heating to about 50-65° C. or by irradiating light.

15. The method of claim 12,
wherein the introduction of the functional group at the end of the ionomer is performed through sulfonation using sulfuric acid.

16. The method of claim 12,
wherein a concentration of the polymerizable monomer is about 3,000-20,000 parts by weight based on 100 parts by weight of the carbon-based catalyst support, and
wherein a concentration of the polymerization initiator is about 0.1-5 parts by weight based on 100 parts by weight of the polymerizable monomer.

17. The method of claim 12,
wherein the polymerization initiator is at least one selected from the group consisting of persulfate, azobisisobutyronitrile, benzoyl peroxide, and lauryl peroxide.

18. An electrode comprising a supported catalyst, comprising:
a carbon-based catalyst support;
catalytic metal particles that are adsorbed onto a surface of the carbon-based catalyst support; and
an ionomer that is chemically bound or physically adsorbed to the carbon-based catalyst support and has a functional group on an end, the functional group being capable of providing proton conductivity.

19. A fuel cell, comprising:
an electrode including a supported catalyst,
wherein the supported catalyst comprises:
a carbon-based catalyst support;
catalytic metal particles that are adsorbed onto a surface of the carbon-based catalyst support; and
an ionomer that is chemically bound or physically adsorbed to the surface of the carbon-based catalyst support and has a functional group on an end, the functional group being capable of providing proton conductivity.

20. The fuel cell of claim 19,
wherein the fuel cell is a direct methanol fuel cell.
